(19) United States
(12) Patent Application Publication
(10) Pub. No.: US 2024/0338247 A1
(43) Pub. Date: Oct. 10, 2024

(54) SYSTEMS AND METHODS FOR FACILITATING DECOUPLED DISTRIBUTION FROM A MAINFRAME TO DISTRIBUTED PLATFORMS

(71) Applicant: THE BANK OF NEW YORK MELLON, New York, NY (US)

(72) Inventors: Marc PULIDO, New York, NY (US); Senthilkumar RAMAKRISHNAN, New York, NY (US)

(21) Appl. No.: 18/623,521

(22) Filed: Apr. 1, 2024

Related U.S. Application Data
(60) Provisional application No. 63/494,302, filed on Apr. 5, 2023.

(51) Int. Cl. G06F 9/48; G06Q 10/067

(52) U.S. Cl. CPC G06F 9/4881; G06Q 10/067

(57) ABSTRACT

Systems and methods for facilitating decoupled distribution from a mainframe to one or more distributed platforms curate a data feed from the mainframe; read the data feed; generate an input file for distribution to an event platform topic representing the data feed; in which the event platform topic is hosted on an event platform; write the input file to the event platform topic; and broadcast the data feed to one or more distributed consumers upon request from a given distributed consumer.

### CROSS-REFERENCE TO RELATED APPLICATIONS

This application claims priority to U.S. Provisional Application No. 63/494,302, filed Apr. 5, 2023, the subject matter of which is incorporated herein by reference in its entirety.

### BRIEF DESCRIPTION

Systems and methods described herein provide a framework to allow decoupled data distribution from a mainframe to distributed platforms.

### BACKGROUND

The modern mainframe has been a key component in business data processing for close to six decades. The robust availability, reliability, and processing throughput of the mainframe are undeniable. Mainframes are the heart of “Enterprise Processing” and integral to the data architecture landscape. However, within the last decade, computing platforms have been migrating away from centralized monoliths and migrating toward distributed architectures: greenfield, virtual machines, containers, functions as a service, cloud, etc. The intersection of these two environments raises questions about how data can easily be accessed and removed from mainframes. Unfortunately, there has been less innovation in the development of new data integrations between the mainframe and distributed environments; solution options in this area are primarily confined to: FTP, NFS, NDM, MQ, Screen Scraping or expensive 3rd party software. Although effective, utilizing these methods for Java-based distributed developers requires utilizing obtuse 3rd party libraries (e.g., C/FLOW, Rocket), expensive enterprise level solution stacks (e.g., NDM/Connect: Direct) or rigid, non-native coordination techniques (e.g., “ready” files, enterprise scheduling, etc.).

Furthermore, mainframes are used as the system of record for many organizations. Batch and online transactions processed by mainframes are often utilized by critical systems, both on and off the mainframe, for daily business processes and transactions. Access of file-based “golden” source data on the mainframe has forced the producer (mainframe process) and the consumer (client) to coordinate distribution of this data by either file transmission, message queue-based system, or interaction with terminal screens. Each additional subscriber to an existing data feed requires coordinated setup between the data provider and consumer, e.g., file name, target server and directory, screen name and access, queue configuration and access, etc. All of this coordination leads to duplicative steps and processing cycles for the identical data to be distributed to multiple endpoints.

Accordingly, systems and methods are needed which allow for data producing processes on the mainframe to decouple data production from data delivery to multiple subscribers.

### SUMMARY

Aspects of the disclosure relate to methods, systems, and/or apparatuses for facilitating decoupled distribution from a mainframe to one or more distributed platforms.

In some aspects, the techniques described herein relate to a method for facilitating decoupled distribution from a mainframe to one or more distributed platforms, including: curating, by a processor, a data feed from the mainframe; reading, by the processor, the data feed; generating, by the processor, an input file for distribution to an event platform topic representing the data feed, wherein the event platform topic is hosted on an event platform; writing, by the processor, the input file to the event platform topic; and providing, by the processor, the data feed to the event platform for broadcasting to one or more distributed consumers upon request from a given distributed consumer.

In some aspects, the techniques described herein relate to a method, wherein, a given data feed is curated based on one or more predefined parameters.

In some aspects, the techniques described herein relate to a method, wherein the data feed is a batch data feed.

In some aspects, the techniques described herein relate to a method, wherein a payload of the input file is one of text, JSON, or Avro.

In some aspects, the techniques described herein relate to a method, wherein the request is triggered by a subscription to the event platform topic.

In some aspects, the techniques described herein relate to a method, wherein the data feed is a repeating data feed.

In some aspects, the techniques described herein relate to a method, further including: receiving, by the processor, from the event platform topic, client-generated data read from a given event platform topic of the event platform; and storing, by the processor, the client-generated data in the mainframe.

In some aspects, the techniques described herein relate to a system for facilitating decoupled distribution from a mainframe to one or more distributed platforms, including: a processor; a data file connected to the processor; and one or more code sets stored in the data file and executing in the processor, which, when executed configure the system to: curate a data feed from the mainframe; read the data feed; generate an input file for distribution to an event platform topic representing the data feed, wherein the event platform topic is hosted on an event platform; write the input file to the event platform topic; and provide the data feed to the event platform for broadcasting to one or more distributed consumers upon request from a given distributed consumer.

In some aspects, the techniques described herein relate to a system, wherein, a given data feed is curated based on one or more predefined parameters.

In some aspects, the techniques described herein relate to a system, wherein the data feed is a batch data feed.

In some aspects, the techniques described herein relate to a system, wherein a payload of the input file is one of text, JSON, or Avro.

In some aspects, the techniques described herein relate to a system, wherein the request is triggered by a subscription to the event platform topic.

In some aspects, the techniques described herein relate to a system, wherein the data feed is a repeating data feed.

In some aspects, the techniques described herein relate to a system, further configured to: receive, from the event platform topic, client-generated data read from a given event platform topic of the event platform; and store the client-generated data in the mainframe.

In some aspects, the techniques described herein relate to a non-transitory, machine-readable medium having instructions for facilitating decoupled distribution from a mainframe to one or more distributed platforms thereon, the instructions when executed by a processor being configured to perform operations including, including: curating a data feed from the mainframe; reading the data feed; generating an input file for distribution to an event platform topic representing the data feed, wherein the event platform topic is hosted on an event platform; writing the input file to the event platform topic; and providing the data feed to the event platform for broadcasting to one or more distributed consumers upon request from a given distributed consumer.

In some aspects, the techniques described herein relate to a non-transitory, machine-readable medium, wherein, a given data feed is curated based on one or more predefined parameters.

In some aspects, the techniques described herein relate to a non-transitory, machine-readable medium, wherein the data feed is at least one of a batch data feed or a repeating data feed.

In some aspects, the techniques described herein relate to a non-transitory, machine-readable medium, wherein a payload of the input file is one of text, JSON, or Avro.

In some aspects, the techniques described herein relate to a non-transitory, machine-readable medium, wherein the request is triggered by a subscription to the event platform topic.

In some aspects, the techniques described herein relate to a non-transitory, machine-readable medium, further including: Receiving from the event platform topic, client-generated data read from a given event platform topic of the event platform; and Storing the client-generated data in the mainframe.

Various other aspects, features, and advantages will be apparent through the detailed description and the drawings attached hereto. It is also to be understood that both the foregoing general description and the following detailed description are illustrative and not restrictive of the scope of the disclosure.

### BRIEF DESCRIPTION OF DRAWINGS

FIG. 1 illustrates a block diagram of a system within which the present techniques may be implemented, in accordance with some embodiments;

FIG. 2 illustrates a block diagram of a system within which the present techniques may be implemented, in accordance with some embodiments;

FIG. 3 illustrates a logic flowchart for facilitating decoupled distribution from a mainframe to one or more distributed platforms, in accordance with some embodiments; and

FIG. 4 illustrates a block diagram depicting an example of a computing device by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

Embodiments of the systems and methods described herein provide a program (referred to herein as a “data publisher”) that allows mainframe applications to deliver data to downstream consumers in a decoupled manner (e.g., with no coordination between publisher and consumer). Utilizing a set of instructions, such as, for example, a JCL script, mainframe batches may publish data to a distributed event store and stream-processing platform (hereinafter “event platform”), such as, for example, Apache Kafka®. For example, in some embodiments, data may be published to a messaging and/or events log or group within the event platform, e.g., Kafka Topics®. In some embodiments, this data “handoff” may be accomplished by the set of instructions calling the data publisher which may reside in Unix System Services (USS is a tightly integrated implementation of Unix within z/OS).

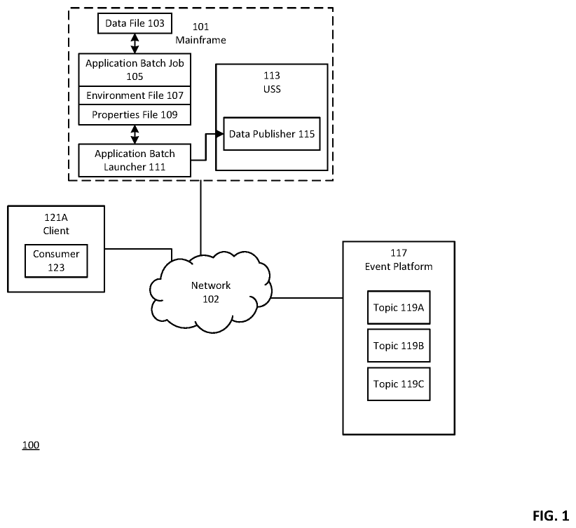

The systems and methods described herein allow for efficient distribution of existing batch datasets or system events to an off-mainframe message or event publishing platform (e.g., Kafka, Pulsar, ActiveMQ, etc.). As shown in FIG. 1, system 100, according to various embodiments, may include a mainframe 101 in communication with an event platform 117 and at least one client 121A, e.g., via network 102. As further shown in FIG. 1, mainframe 101 may include at least the following components: data file 103, application mainframe batch job 105, application environment file 107, application properties file 109, java batch launcher 111, and USS 113, as described herein. In some embodiments, USS 113 may host Java-based data publisher 115, to which java batch launcher 111 may be connected, as described herein.

As illustrated in FIG. 1, each of mainframe 101, event platform 117, and client 121A may communicate via the network 121. In some examples, each of the elements depicted may be executed on a respective computing system, though this need not always be the case. In some examples, one or more of the elements may be executed on a single computing system (which is not to suggest that such a computing system may not comprise multiple computing devices or nodes, or that each computing device or node need be co-located, indeed, a computing system comprising multiple servers that house multiple computing devices may be operated by a single entity and the multiple servers may be distributed, e.g., geographically).

For example, in some embodiments, an entity may comprise a mainframe computer or server, such as mainframe 101, while communicating remotely, e.g., via network 102, with other computers or processors which may host other aspects of the system. Moreover, in some examples, the entity may also provide employees or third parties (e.g., customers, contractors, etc.) access to a client (e.g., client 121A), which may be a web-based application hosted by a computing system managed by or provisioned by the entity, or which communicates with such a computing system via an application programming interface. Accordingly, one or more of the depicted entities may communicate with one another via messages transmitted over network 102, such as the Internet and/or various other local area networks. For example, one or more applications may communicate via messages transmitted over the network 102.

In some embodiments, the system may be configured to be modular and configuration driven. This may allow development teams to integrate embodiments of the solution with minimal coding impact to existing mainframe data or report producing batch jobs. In some embodiments, the system may be configured as a dedicated application mainframe batch job, e.g., as shown in FIG. 1, or it may be added as steps to an existing mainframe batch job card. This allows the data producing job to decouple its data production processing from its data distribution functionality.

A purpose of the application mainframe batch job 105 is to assign the application environment file 107 and the application properties file 109, as well as the data publisher application class to the java batch launcher 111 for execution. Java batch launcher 111, e.g., IBM® Stored Procedure JZOS Java Batch Launcher (JVMPRC86), is a facility that the mainframe provides to allow mainframe batch jobs to run Java Applications. As understood herein, batch jobs or batch applications are processed on the mainframe without user interaction. A batch job is submitted on the computer, the job reads and processes data in bulk and produces output, such as customer information, transaction data, and/or other data records, etc.

In some embodiments, data publisher 115 may be, for example, a Java based application that runs on the Unix System Services (USS) 113 segment of mainframe 101. USS 113 may be a POSIX-like environment that provides Unix-like functionality providing the same commands and utilities and may run Java Applications natively. Data publisher 115 may be, for example, a Java application to allow it to access Java Libraries from various message/event platform providers (e.g., Kafka, Pulsar, ActiveMQ, etc.). This allows data publisher 115 to be event platform agnostic while allowing flexibility via configuration. By executing as a Java application on the USS environment, data publisher 115 is eligible to run on cost-efficient processors (e.g., zIIP), which allows data publisher 115 to distribute data (e.g., data file 103) at a lower cost footprint than a traditional batch running on the general processor. In some embodiments, data publisher 115 may be configured to read the data file 103 provided to it and write data records to event platform 117. Specifically, in some embodiments, data publisher 115 may be configured to write data records to one or more specific event publisher topics, e.g., topic 119A, 119B, and/or 119C, etc. As understood herein, a topic may refer to a category or a common name used to store and publish a particular stream of data. Topics in an event platform such as event platform 117 may be similar to tables in a database, but not containing all the constraints of a database. For example, any number of topics may be generated. Users may then subscribe to specific topics (e.g., via a client such as client 121A) and receive data published via data processor 115.

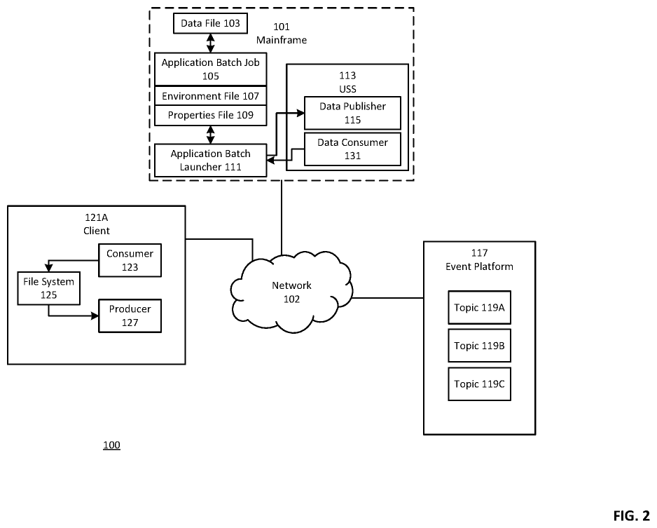

As shown in FIG. 2, in some embodiments, data publisher 115 may be configured with logic for retries on failure and/or may have a configured checkpoint facility to keep track of the last successful record written. By configuration, data publisher 115 may also act as a data consumer 131 against the same event publisher platform 117 and read back the specified data topic, e.g., from file system 125, without changing the codebase. This allows the bi-directional functionality for data publisher 115 in which data may be read back to a producer 127 and sent back to event platform 117, which may then send the data back to data consumer 131. It should be noted that, while shown herein as separate elements, in various embodiments data publisher 115 and data consumer 131 may represent one element with multiple functionalities, e.g., performed by the same program. Furthermore, in various embodiments, the same application(s) may run on mainframe 101/USS 112 or client 121A.

As shown in FIG. 2, in various embodiments, data publisher 115 may allow for efficient data distribution by utilizing the Event Platform topics and having client systems read its associated data feed from the topic, off the mainframe 101, and not have to deliver a specific file. This effectively allows data publisher 115 to implement a 1-to-N write by having multiple clients (e.g., client 121A, client 121B, client 121C, etc.) access identical data for their business processing needs while data publisher 115 only writes the data once (e.g., via one of topics 119A, 119B, 119C, etc.). This architecture effectively “decouples” the production of business process data from its consumption, ensuring the delivery of identical data to various consumers, while allowing the clients to access the data when they are ready to process it.

In some embodiments, data publisher 115 may be dependent on configuration for both its run environment as well as its target distribution platform. Accordingly, in some embodiments the run environment for data publisher 115 may be set up via an application environment file 107. This allows users to configure run environment details such as, e.g., library paths, binary locations, logging properties, memory properties, etc. In some embodiments, data publisher 115 may also utilize an application properties file 109, which may affect how data publisher 115 functions in different conditions or situations. In some embodiments, application properties file 109 may contain, for example, configurable runtime information such as, e.g., input file name, topic name, checkpoint information, credentials, polling limits, etc. Application properties file 109 may allow the same data publisher 105 to publish different data files to various topics, thus allowing different Application Teams to alter execution functionality of data publisher 115 simply by changing application properties file 109 (e.g., configurable input, output, topics, checkpoints). In some embodiments, application properties file 109 may also be overridden by passing attributes directly as parameters to data publisher 115 application. Although rare, this does allow for further configurability by bypassing certain attributes within the applications properties files 109.

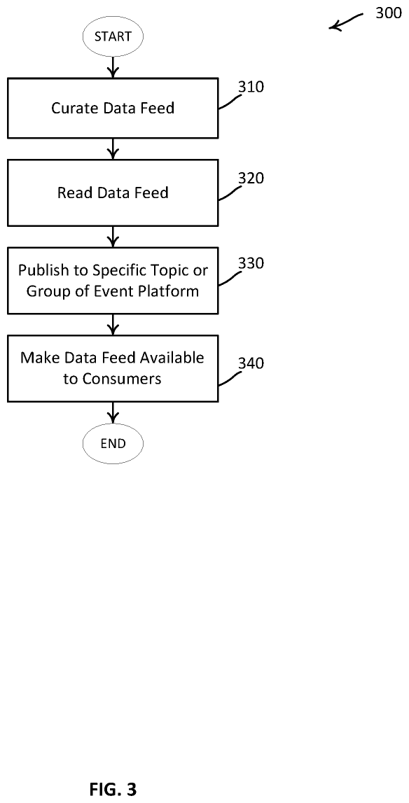

FIG. 3 shows a method flow 300 according to various embodiments. At step 310, a Batch job is configured to curate (e.g., create) a data feed (e.g., an hourly feed, a daily feed, or other repeating data feed) for distribution from the mainframe. In some embodiments, various data feeds may be created which contain data regularly requested by members of an organization. Such data may be resident on the mainframe and therefore otherwise difficult to access, and yet necessary for other processes. Accordingly, data publisher 115 may be configured to curate various different data feeds for distribution purposes (without disturbing the mainframe data), based on one or more predefined parameters, e.g., as defined or modified in application properties file 109, as described herein.

In some embodiments, at step 320, data publisher 115 may be configured to trigger an event platform job that will read the data feed (e.g., from application batch job 105) and at step 330 data publisher 115 may publish the data feed to a specific topic or group of an event platform (e.g., to a Kafka Topic) representing the feed data. As described herein, data publisher 115 may be configured to publish different data files to various topics, e.g., based on application properties file 109. Accordingly, the Java based framework may be configured to read a configured input file (e.g., the data feed) and write to a specific configured topic or group, e.g., a Kafka Topic. In some embodiments, the payload may be text, JSON, Avro, etc.

In some embodiments, at step 340, a distributed consumer (e.g., Greenfield, AppEngine, Cloud) may subscribe (or be previously subscribed) to receive the feed, e.g., by subscribing to receive information posted to a specific topic or topics (e.g., a “daily feed” Kafka Topic), enabling the consumer to process the data in the feed when available (batch, poll, etc.). Accordingly, in some embodiments, the data feed may be made available to consumers who are subscribed. Alternatively, users (consumers) may execute a request to retrieve data feeds posted to specific topics.

In some embodiments, authentication mechanisms may be provided, e.g., to protect against unauthorized read and/or write access with respect to data residing on or received from the mainframe. For example, at various stages in the process (e.g., at the mainframe, in the USS environment, on the event platform, at the client, etc.), one or more identification codes (ID), e.g., associated with various users and/or information, may be requested and/or automatically checked, prior to access being granted for a given data feed. Furthermore, in some embodiments, certain users may only be granted access to specific topics, and therefore to the data feeds published to those topics. Additionally, due to the care taken with respect to mainframe data, ID may be required in order to write to the mainframe (e.g., via data consumer 131).

Accordingly, various embodiments of the systems and methods described herein provide a variety of benefits, including but not limited to, the following: configuration of a event platform cluster, e.g., a server cluster; configuration of one or more event platform topics (e.g., on one or more server clusters) to publish to and/or consume from; configuration of dataset(s) to read from/write to; authorization/authentication to event platform clusters and topics; replay capability; logging; portable java libraries (run on USS, Linux, Windows); zIIP eligible processing; no vendor costs or recurring maintenance fees.

In some embodiments, to access the data that was published by a mainframe, e.g., mainframe 101, distributed consumers simply need to have the following configured: event platform cluster and/or event platform topic, and credentials to connect to the cluster and/or topic. The framework described herein may be utilized for this capability as well, allowing distributed consumers to retrieve the “mainframe” data and process it how they see fit. Systems and methods described herein also enable the data “roles” to be reversed, e.g., distributed producers writing to event platform topics and mainframe consumers retrieving and processing this data. All of this capability may be enabled by having the exact same Java JARs (or equivalent program/application) running in both the mainframe and distributed environments (Windows, Unix, Linux, container, etc).

By basing the innovative architecture around a distributed event store and stream-processing platform, such as, for example Apache Kafka®, embodiments of the systems and methods described herein allow for dissemination of mainframe data to any number of downstream consumers without having the publisher code or configure for those additional downstream targets, completely decoupling producer from consumer. Utilizing, e.g., Java on USS also allows the data publishing process to be zIIP eligible on the mainframe and execute against low-cost processors, significantly lowering the overall cost of data distribution.

Embodiments of the systems and methods described herein overcome many of the challenges of legacy mainframe systems by incorporating a producer on the mainframe that facilitates the publishing of data by Mainframe batches to, e.g., event platform topics or the like. The process may also operate in the opposite direction as described herein,—the producer may be configured to read information from a messaging and/or events log or group (e.g., a Kafka Topic) and write to the mainframe. In some embodiments, a log file may be maintained, e.g., in the event platform and/or on the mainframe, such that a cluster of the event platform knows when its last communication occurred and can resume from that point in time. For example, in some embodiments, the event platform may keep track of where a client left off while the data publisher 115 may track data that is sent so it can be rerun at a later point in time (e.g., for disaster recovery, etc.).

Embodiments of the systems and methods described herein enable exchanging data between the mainframe and Distributed Sources with: a simple MVS Batch Command; no FTP; no NDM; no MQ or MQ manager required; no green screen scraping; no CICS; near real-time access to data; event-based data; no servers required to be owned (e.g., for existing situations in which hardware is already in place); and no “handshakes,” e.g., Producer and Consumer completely “decoupled.”

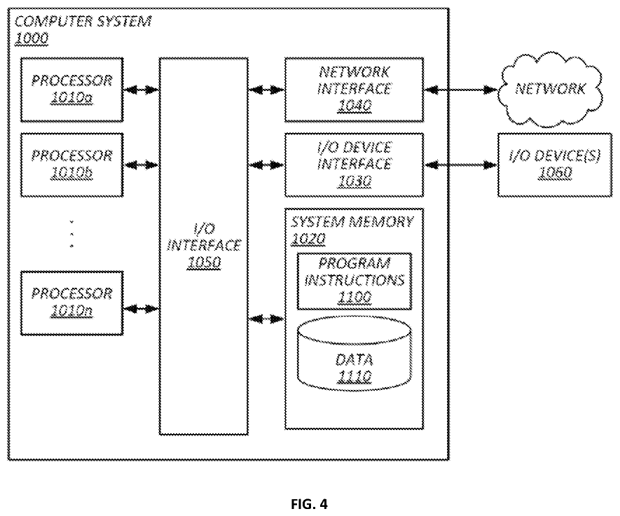

Some embodiments may execute the above operations on a computer system, such as the computer system of FIG. 4, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

In some embodiments, I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors.

Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this disclosure, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A method for facilitating decoupled distribution from a mainframe to one or more distributed platforms, comprising:
curating, by a processor, a data feed from the mainframe;
reading, by the processor, the data feed;
generating, by the processor, an input file for distribution to an event platform topic representing the data feed, wherein the event platform topic is hosted on an event platform;
writing, by the processor, the input file to the event platform topic; and
providing, by the processor, the data feed to the event platform for broadcasting to one or more distributed consumers upon request from a given distributed consumer.

2. The method as in claim 1, wherein, a given data feed is curated based on one or more predefined parameters.

3. The method of claim 1, wherein the data feed is a batch data feed.

4. The method of claim 1, wherein a payload of the input file is one of text, JSON, or Avro.

5. The method of claim 1, wherein the request is triggered by a subscription to the event platform topic.

6. The method of claim 1, wherein the data feed is a repeating data feed.

7. The method of claim 1, further comprising:
receiving, by the processor, from the event platform topic, client-generated data read from a given event platform topic of the event platform; and
storing, by the processor, the client-generated data in the mainframe.

8. A system for facilitating decoupled distribution from a mainframe to one or more distributed platforms, comprising:
a processor;
a data file connected to the processor; and
one or more code sets stored in the data file and executing in the processor,
which, when executed configure the system to: curate a data feed from the mainframe;
read the data feed;
generate an input file for distribution to an event platform topic representing the data feed, wherein the event platform topic is hosted on an event platform;
write the input file to the event platform topic; and
provide the data feed to the event platform for broadcasting to one or more distributed consumers upon request from a given distributed consumer.

9. The system as in claim 8, wherein, a given data feed is curated based on one or more predefined parameters.

10. The system as in claim 8, wherein the data feed is a batch data feed.

11. The system as in claim 8, wherein a payload of the input file is one of text, JSON, or Avro.

12. The system as in claim 8, wherein the request is triggered by a subscription to the event platform topic.

13. The system as in claim 8, wherein the data feed is a repeating data feed.

14. The system as in claim 8, further configured to:
receive, from the event platform topic, client-generated data read from a given event platform topic of the event platform; and
store the client-generated data in the mainframe.

15. A non-transitory, machine-readable medium having instructions for facilitating decoupled distribution from a mainframe to one or more distributed platforms thereon, the instructions when executed by a processor being configured to perform operations comprising, comprising:
curating a data feed from the mainframe;
reading the data feed;
generating an input file for distribution to an event platform topic representing the data feed, wherein the event platform topic is hosted on an event platform;
writing the input file to the event platform topic; and
providing the data feed to the event platform for broadcasting to one or more distributed consumers upon request from a given distributed consumer.

16. The non-transitory, machine-readable medium as in claim 15, wherein, a given data feed is curated based on one or more predefined parameters.

17. The non-transitory, machine-readable medium as in claim 15, wherein the data feed is at least one of a batch data feed or a repeating data feed.

18. The non-transitory, machine-readable medium as in claim 15, wherein a payload of the input file is one of text, JSON, or Avro.

19. The non-transitory, machine-readable medium as in claim 15, wherein the request is triggered by a subscription to the event platform topic.

20. The non-transitory, machine-readable medium as in claim 15, further comprising:
Receiving from the event platform topic, client-generated data read from a given event platform topic of the event platform; and
Storing the client-generated data in the mainframe.
